(19) United States
(12) Patent Application Publication
(10) Pub. No.: US 2012/0107626 A1
(43) Pub. Date: May 3, 2012

(54) Adhesive or sealing compounds containing alkoxysilane-terminated polymers

(75) Inventors: Wolfram Schindler, Tussling (DE); Volker Stanjek, Ampfing (DE)

(73) Assignee: Wacker Chemie AG, Munich (DE)

(21) Appl. No.: 13/381,277

(22) PCT Filed: Jun. 22, 2010
(86) PCT No.: PCT/EP10/58795

§ 371 Date: Dec. 28, 2011

(30) Foreign Application Priority Data
Jun. 30, 2009 (DE) 10 2009 027 357.3

(51) Int. Cl. B32B 9/04; C09J 183/16

(52) U.S. Cl. 428/447; 524/588

(57) ABSTRACT

Two-component adhesive or sealing compounds (K), comprising a first component (K1), containing silane-terminated prepolymers (A), which have end groups of the general formula (II) —O—CO—NH—(CH₂)_{y}—SiR²₃₋ₓ(OR¹)ₓ (II), where R¹ and R² independently from each other are hydrocarbon groups having 1-18 carbon atoms or ω-oxaalkyl-alkyl groups having in total 2-20 carbon atoms, x is 2 or 3, and y is a number from 1 to 10, and a second component (K2), containing water, provided that at least 50% of all prepolymer molecules (A) do not have any additional urethane or urea units in the backbone of the prepolymer chain.

### CROSS REFERENCE TO RELATED APPLICATIONS

This application is the national phase filing of international patent application No. PCT/EP2010/058795, filed 22 Jun. 2010, and claims priority of German patent application number 10 2009 027 357.3, filed 30 Jun. 2009, the entireties of which applications are incorporated herein by reference.

### FIELD OF THE INVENTION

The invention relates to two-component adhesive or sealing compounds based on silane-terminated prepolymers.

### BACKGROUND OF THE INVENTION

Polymer systems possessing reactive alkoxysilyl groups have been known for a long time. On contact with water or air humidity, these alkoxysilane-terminated polymers are capable even at room temperature of condensing with one another to eliminate the alkoxy groups. One of the most important applications of such materials is the production of adhesives and sealants, especially of elastic adhesive systems.

For instance, adhesives based on alkoxysilane-crosslinking polymers in the cured state exhibit not only very good adhesive properties on a wide variety of different substrates, but also very good mechanical properties, since they can be both tear-resistant and highly elastic. A further crucial advantage of silane-crosslinking systems over numerous other adhesive and sealant technologies (for example over isocyanate-crosslinking systems) is the toxicological safety of the prepolymers.

In many applications, preference is given to one-component systems (1K systems) which cure only through contact with the air humidity. The crucial advantage of one-component systems is, in particular, the very easy applicability thereof, since no mixing of different adhesive components by the user is required here. In addition to the time/labor saving and the reliable avoidance of any metering errors, it is not even necessary in the case of one-component systems to process the adhesive/sealant within a usually quite narrow time window, as is the case for two-component systems (2K systems) after the two components have been mixed.

However, 1K systems possess the crucial disadvantage, which is inherent to the system, of curing only on contact with (air) humidity. In the case of deep joints and/or large-area adhesive bonds, this leads to extremely slow curing “from the outside inward”, the progress of which becomes slower the further the curing advances on account of the increasingly long diffusion pathways. This is especially true in the case of adhesive bonding of nonporous substrates (plastics, steel and other metal alloys, paint surfaces, glass and glazed surfaces, etc.), in which this problem cannot even be solved by prior homogeneous moistening of the adhesion surface. The result is a low initial strength, which may even necessitate fixing of the parts to be bonded, but in any case makes full stress on the adhesion surface impossible over the course of days or even weeks. In the case of corresponding joints and bonds, the use of 2K systems is thus advantageous or often even simply unavoidable.

2K adhesive systems based on silane-crosslinking prepolymers have already been disclosed in EP 227 936 B1, EP 824 574 B1 and in WO 2008/153392 A1. The corresponding systems are based on what are called the MS polymers (silane-terminated polyethers from Kaneka), as in EP 824 574 B, or else on SPUR polymers (silane-terminated polyurethanes based on aminoalkyl-functional silanes, diisocyanates and polyethers), as in EP 227 936 B1 and WO 2008/153392 A1, and have end groups of the formula (I)

—(CH₂)₃—Si(CH₃)(OCH₃)₂ (I)

The MS and/or SPUR polymers are processed with plasticizers, fillers, tin catalysts and further components, for example stabilizers, to give a first component. The second component used is a pasty aqueous mixture which, as well as water, typically comprises chalk, thickeners, for example cellulose derivatives, and optionally also further components.

A disadvantage of these systems according to the prior art is especially the low reactivity of the corresponding MS or SPUR polymers toward moisture, which necessitates aggressive catalysis. The corresponding mixtures therefore typically comprise considerable amounts of toxicologically unsafe tin catalysts. If the reactivity in the case of 2K systems is set to be very slow in order to obtain a sufficiently long processing time, there may additionally be problems in the course of curing. For instance, relatively minor application errors here can lead to clear defects in the course of curing.

A further disadvantage of such aggressive (tin) catalysis is the adverse effects of these catalysts on the storage stability of the corresponding compounds. For instance, these highly reactive catalysts can firstly catalyze side reactions or degradation reactions of the silane-terminated polymers; secondly, catalytically active intermediates over the course of time generally first build up in the formulations and decay again only after a prolonged period. In the first case, the catalysts have an adverse effect, for example, on thermal stability of the corresponding adhesives. Typical degradation reactions are in particular the cleavage of the urethane and/or urea units in the prepolymer backbone, which occurs in the case of SPUR polymers, and also the cleavage—though it usually proceeds more slowly—of the ether bonds and of any ester bonds likewise present in the polymers. In the latter case, the curing rate and also the open times of the 2K formulation will change in the course of storage. The user is thus unable to estimate the processing time since it depends on the storage time of the product. This is unacceptable especially for automated processes.

A further disadvantage of the silane-terminated polymers described to date is incomplete silane termination of the chain ends in many cases. Therefore, these materials contain unreactive chain termini which are thus uncrosslinked in the cured state, which can lead to mediocre mechanical properties and residual tack which is maintained even after the curing.

Aminosilane-terminated “SPUR polymers”, in contrast, have the no less crucial disadvantage of a relatively high viscosity which is caused by the urethane and urea bonds present in the material. These form what are called “polyurethane hard blocks” via hydrogen bonds, which of course are formed at an earlier stage than in the cured material, also actually in the liquid or viscous prepolymer, in some cases sharply increasing the viscosity thereof. This high viscosity is very disadvantageous for 2K systems because it complicates homogeneous mixing of the two components.

### SUMMARY OF THE INVENTION

It was an object of the present invention to provide 2-component adhesives or sealants based on silane-terminated polymers, with which the disadvantages of the prior art can be overcome. The aim here was not just simple and reliable catalysis, but also formulations which do not have any major changes in reactivity over the course of storage. In addition, the two components were to be miscible in a simple manner without any great influences on curing.

### DETAILED DESCRIPTION OF THE INVENTION

The invention provides two-component adhesive or sealing compounds (K) comprising a first component (K1) comprising silane-terminated prepolymers (A) having end groups of the general formula (II)

—O—CO—NH—(CH₂)_{y}—SiR²₃₋ₓ(OR¹)ₓ (II)

where
R¹ and R² are each independently hydrocarbyl radicals having 1-18 carbon atoms or ω-oxaalkylalkyl radicals having a total of 2-20 carbon atoms,
x is 2 or 3 and
y is a number from 1 to 10,

and a second component (K2) comprising water,

with the proviso that at least 50% of all prepolymer molecules (A) do not have any additional urethane or urea units in the backbone of the prepolymer chain.

The R¹ and R² radicals are preferably hydrocarbyl radicals having 1 to 6 carbon atoms, especially alkyl radicals having 1 to 4 carbon atoms.

R² is preferably a methyl radical.

R¹ is preferably a methyl or ethyl radical.

y is preferably 1 or 3.

Examples of R¹ and R² are alkyl radicals such as the methyl, ethyl, n-propyl, isopropyl, n-butyl, isobutyl, tert-butyl, n-pentyl, isopentyl, neopentyl, tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical; alkenyl radicals such as the vinyl and allyl radical; cycloalkyl radicals such as cyclopentyl, cyclohexyl, cycloheptyl radicals and methylcyclohexyl radicals; aryl radicals such as the phenyl and naphthyl radicals; alkaryl radicals such as o-, m-, p-tolyl radicals, xylyl radicals and ethylphenyl radicals; aralkyl radicals such as the benzyl radical, the α- and β-phenylethyl radicals.

Preferably at least 70%, more preferably at least 90%, of all prepolymer molecules (A) do not have any additional urethane or urea units in the backbone thereof. More preferably, no prepolymer molecules contain any additional urethane or urea units in the backbone thereof.

The prepolymers (A) preferably comprise silane-terminated polyethers, i.e. molecules whose polymer backbone consists exclusively of polyethers. The mean molar masses Mₙ (Mₙ=number average) of the prepolymers (A) are preferably between 3200 and 22 500 g/mol, preference being given to mean molar masses of 8200 to 20 500 g/mol and very particular preference to mean molar masses of 10 200 to 18 500 g/mol.

Preferably, prepolymers (A) contain end groups of the general formula (III)

—O—CO—NH—(CH₂)—SiR²₃₋ₓ(OR¹)ₓ (III)

where R¹, R² and x are each as defined for formula (II).

The second component (K2) comprises, as well as water, preferably also a thickener (V). It is preferably in the form of a paste or gel.

The inventive compounds (K) have the advantage that silane-functional prepolymers (A) with end groups of the formula (II) or (III), in spite of comparatively low prepolymer viscosities, cure to give tack-free compounds with good mechanical properties. In addition, in two-component systems, they exhibit much faster curing than is known from the systems described in the prior art. This is especially true for prepolymers (A) with end groups of the formula (III), and therefore particular preference is also given to two-component adhesives or sealants (K) on this prepolymer basis. The high curing rate not only allows very early mechanical stressability of the adhesive seam or adhesive surface, which, particularly in industrial processes—for example in the motor vehicle industry—allows rapid production and high numbers of units per unit time, but also makes it possible to dispense with toxicologically unsafe tin catalysts. In addition, it has been found that, after storage of the two components, there is virtually no discernible change in the curing times (or pot lives). This change is often criticized in commercial products comprising polymers according to the prior art to date. A further positive effect of the favorable and reliable miscibility and catalysis is that the mechanical properties of the two-component compounds barely differ from those of an analogous one-component compound (cured without addition of water, merely by means of air humidity).

Therefore, the inventive adhesive or sealant compounds (K) preferably contain such small amounts of tin catalysts that the tin content is not more than 100 ppm by weight, based on the total weight of the compound (K). It does not matter whether the tin catalyst(s) is/are present in component (K1) or (K2) or in both adhesive components. The inventive adhesives or sealants (K) are preferably entirely free of tin-containing catalysts, especially organic tin compounds. The inventive adhesive or sealing compounds (K) are more preferably free of any heavy metal-containing catalysts. Catalysts are understood in this context to mean compounds which are capable of catalyzing the curing of the adhesive or sealing compounds (K).

In a preferred mode of preparation of the polymers (A), a silane (Al) selected from silanes of the general formula (IV)

OCN—(CH₂)—SiR²₃₋ₓ(OR¹)ₓ (IV)

is used, where R¹, R² and x are each as defined for formula (II).

The silane (A1) is preferably reacted with an oligomeric or polymeric di-, tri- or tetraol (A2), particular preference being given to diols. The compounds (A2) used are preferably unbranched, long-chain polyethers which are terminated by hydroxyl groups and are of the general formula

HO—Z—OH (V)

where Z is a polyether radical,

preferably a radical of the formula —(R³O)ₘ—

where

R3 may be the same or different and is optionally substituted hydrocarbylene radicals, preferably methylene, ethylene or 1,2-propylene radicals, and

m is an integer.

Particular preference is given to unbranched long-chain polypropylene glycols. The mean molar masses Mₙ (Mₙ=weight average) of these polyethers (A2) used with preference are between 3500 and 22 000 g/mol, preference being given to mean molar masses of 8000 to 20 000 g/mol and particular preference to mean molar masses of 10 000 to 18 000 g/mol. Examples of particularly suitable polyols (A2) are commercially available under the Acclaim° 12200, Acclaim® 18200 brands from Bayer MaterialScience AG, Germany.

The stoichiometries of reaction partners (A1) and (A2) are preferably selected such that more than 85% of all chain ends, preferably more than 90% and more preferably more than 95% of all chain ends are terminated by silane functions. This complete or virtually complete termination of the chain ends surprising leads to a distinct improvement in the mechanical properties of the cured compounds (K) based on these materials, compared to the compositions which are based on conventional MS polymers and are described in EP 824 574 B1.

The polyethers (A2) are preferably long-chain polypropylene glycols without any additional urethane and/or urea units in the polymer backbone. Thus, the reaction thereof with the silanes (A1) does not give any silane-terminated polyurethanes, but rather prepolymers (A) which contain only exactly two urethane units per molecule. Since the preferred use of polypropylene glycols (A2) with the abovementioned high molar masses results in prepolymers (A) of very high molecular weight, these two urethane units per molecule have virtually no influence on the viscosity of the corresponding materials. The formation of polyurethane hard blocks which occurs in the SPUR polymers described in WO 2008/153392 A1 does not occur here. The resulting inventive prepolymers (A) are accordingly of much lower viscosity with the same molecular weight. The inventive cured sealants or adhesives (K), in contrast—in spite of the lack of the abovementioned polyurethane hard blocks—have surprisingly good and comparable mechanical properties.

Preferably, therefore, the silane-terminated prepolymers (A) used are silane-terminated polyethers of the general formula

(R¹O)ₓR²₃₋ₓSi—(CH₂)—NH—CO—O—Z—O—CO—NH—(CH₂)—SiR²₃₋ₓ(OR¹)ₓ (VI)

where R¹, R² and x are each as defined for formula (II) and Z is a polyether radical and is preferably as defined for formula (V).

The inventive prepolymers (A) preferably have, in the undiluted state, viscosities of not more than 50 Pas at 25° C., preferably not more than 35 Pas at 25° C., and preferably mean molecular masses Mₙ of 15 000 to 20 000 g/mol, more preferably viscosities of not more than 25 Pas at 25° C., especially not more than 15 Pas at 25° C., and preferably mean molecular masses Mₙ of 10 000 to 15 000 g/mol. Such low viscosities cannot be achieved with the SPUR polymers described in the prior art with comparable molar masses.

In the preparation of the prepolymer (A), the concentrations of all isocyanate groups involved in all reaction steps and of all isocyanate-reactive groups, and the reaction conditions, are preferably selected such that all isocyanate groups react in the course of the polymer synthesis. The finished polymer (A) is thus preferably isocyanate-free. Freedom from isocyanates can also be achieved by using the isocyanatosilanes (A1) in excess in relation to the polyol (A2), but, after the silane termination, scavenging the excess isocyanate groups by adding a further isocyanate-reactive component, for example an alcohol such as methanol or ethanol.

The prepolymers (A) are preferably prepared in the presence of a catalyst. The preparation can be effected continuously or batchwise. Suitable catalysts, processes and reaction conditions for preparation of the prepolymers (A) are described, for example, in DE 10 2005 029 169 A1 and US 2005/0119436 A.

In the inventive two-component adhesive and sealing compounds (K), component (K1) comprises, as well as the silane-terminated prepolymer (A), preferably also condensation catalysts (KK), water scavengers and silane crosslinkers (S), fillers (F), plasticizers (W), adhesion promoters (H), rheology aids (R) and stabilizers (St), optionally additionally also color pigments and further customary assistants and additives.

The condensation catalysts (KK) used may, for example, be titanate esters such as tetrabutyl titanate, tetrapropyl titanate, tetraisopropyl titanate, tetraacetylacetonate titanate;

tin compounds such as dibutyltin dilaurate, dibutyltin maleate, dibutyltin diacetate, dibutyltin dioctanoate, dibutyltin acetylacetonate, dibutyltin oxide, or corresponding compounds of dioctyltin;

basic catalysts, for example aminosilanes such as aminopropyltrimethoxysilane, aminopropyltriethoxysilane, aminopropylmethyldimethoxysilane, aminopropylmethyl-diethoxysilane, N-(2-aminoethyl)aminopropyltrimethoxy-silane, N-(2-aminoethyl)aminopropyltrimethoxysilane, N-(2-aminoethyl) aminopropyltriethoxysilane, N-(2-amino-ethyl)aminopropylmethyldimethoxysilane, N-cyclohexyl-aminomethyltriethoxysilane, N-cyclohexylamino-methylmethyldiethoxysilane, N-cyclohexylamino-methyltrimethoxysilane, N-cyclohexylaminomethylmethyl-dimethoxysilane and other organic amines such as triethylamine, tributylamine, 1,4-diazabi-cyclo[2.2.2]octane, N,N-bis(N,N-dimethyl-2-amino-ethyl)methylamine, N,N-dimethylcyclohexylamine, N,N-dimethylphenylamine, N-ethylmorpholine, etc.

or acidic catalysts such as phosphoric acid or phosphoric esters, toluenesulfonic acids, mineral acids, preference being given to heavy metal-free catalysts.

The condensation catalysts (KK) are preferably used in concentrations of 0.01-10% by weight, more preferably 0.1-2% by weight, based in each case on the total weight of component (K1). The different catalysts can be used either in pure form or in the form of mixtures.

The water scavengers and silane crosslinkers (S) used may, for example, be vinylsilanes such as vinyltrimethoxy-, vinyltriethoxy-, vinylmethyldimethoxy-, glycidoxypropyltrimethoxysilane, glycidoxypropyltriethoxysilane, O-methylcarbamatomethyl methyldimethoxysilane, O-methylcarbamatomethyltrimethoxy-silane, O-ethylcarbamatomethylmethyldiethoxysilane, O-ethylcarbamatomethyltriethoxysilane, alkylalkoxysilanes in general, or else further organofunctional silanes. It is of course possible here too to use the same aminosilanes as have already been described for the condensation catalysts (KK). These silanes then often assume a double function as a catalyst and crosslinker silane. All silane crosslinkers (S)—especially all silanes with amino or glycidoxy functions—can additionally also serve as an adhesion promoter.

The water scavengers and silane crosslinkers (S) are preferably used in concentrations of 0.1-10% by weight, preferably 0.5-2% by weight, based in each case on the total weight of component (K1).

The fillers (F) used may, for example, be calcium carbonates in the form of natural ground chalks, ground and coated chalks, precipitated chalks, precipitated and coated chalks, clay minerals, bentonites, kaolins, talc, titanium dioxides, aluminum oxides, aluminum trihydrate, magnesium oxide, magnesium hydroxide, carbon blacks, precipitated or fumed, hydrophilic or hydrophobic silicas.

Preference is given to using calcium carbonates and precipitated or fumed, hydrophilic or hydrophobic silicas, more preferably fumed, hydrophilic or hydrophobic silicas, especially fumed, hydrophobic silicas, as the filler (F).

The fillers (F) are preferably used in concentrations of 10-70% by weight, preferably 30-60% by weight, based in each case on the total weight of component (K1).

The plasticizers (W) used may, for example, be phthalate esters such as dioctyl phthalate, diisooctyl phthalate, diundecyl phthalate, adipic esters such as dioctyl adipate, benzoic esters, glycol esters, phosphoric esters, sulfonic esters, polyesters, polyethers such as polyethylene glycol and polypropylene glycol, polystyrenes, polybutadienes, polyisobutenes, paraffinic hydrocarbons, higher branched hydrocarbons, etc.

The plasticizers (W) are preferably used in concentrations of 0 to 40% by weight, based on the total weight of component (K1).

The rheology aids (R) used may, for example, be thixotropic agents. Examples here include hydrophilic fumed silicas, coated hydrophobic fumed silicas, precipitated silicas, polyamide waxes, hydrogenated castor oils, stearate salts or precipitated chalks. The abovementioned fillers can also be used to adjust the flow properties.

The thixotropic agents are preferably used in concentrations of 1-5% by weight, based on the total weight of component (K1).

The stabilizers (St) used may, for example, be antioxidants or light stabilizers, such as what are called HALS stabilizers, sterically hindered phenols, thioethers or benzotriazole derivatives.

In addition, component (K1) may also comprise fungicides, biocides, flame retardants, pigments etc.

The proportion of alkoxysilane-terminated prepolymers (A) in component (K1) is preferably 10-70% by weight, more preferably 15-50% by weight, especially preferably 20-40% by weight, based in each case on the total weight of component (K1).

In a further embodiment of the invention, component (K1) comprises, as well as the inventive prepolymers (A) with end groups of the general formula (III), also prepolymers with end groups of the general formula (VII)

—O—CO—NH—(CH₂)₃—SiR²₃₋ₓ(OR¹)ₓ (VII)

where all variables R¹, R² and x are as defined for formula (II). The mixing ratios between the two abovementioned prepolymer types are preferably between 1:10 and 10:1, more preferably between 1:3 and 3:1, based in each case on the weight.

Component (K2) of the inventive two-component adhesive and sealing compound comprises, as well as water, preferably plasticizers and fillers.

The plasticizers (W), as described above, are preferably used in concentrations of 0-98% by weight, more preferably 30-90% by weight, based on the total weight of component (K2).

In addition, component (K2) may also comprise fillers (F), as described above, in concentrations of preferably 10-70% by weight, more preferably 30-60% by weight, based in each case on the total weight of component (K2).

Furthermore, component (K2) may comprise thickeners (V). These are preferably water-soluble or water-swellable polymers, or inorganic thickeners. Examples of organic thickeners (V) include starch, dextrins, oligosaccharides, cellulose, cellulose derivatives such as carboxymethylcellulose, cellulose ethers, methylcellulose, hydroxyethylcellulose or hydroxypropylcellulose, agar-agar, alginates, pectins, gelatins, carrageen, tragacanth, gum arabic, casein, polyacrylamide, poly(meth)acrylic acid derivatives, polyvinyl ethers, polyvinyl alcohols, polyamides or polyimines. Examples of inorganic thickeners are polysilicas, fumed silicas, aluminosilicates or clay minerals. The preferred amounts of the thickeners are 0-10% by weight, based on the total weight of component (K2).

Moreover, further rheology aids (R) as described above can be added. The thixotropic agents are preferably added in concentrations of 0-5% by weight, based on the total weight of component (K2).

Water is present in component (K2) preferably in amounts of 0.1-25% by weight, more preferably 0.5-5% by weight, based in each case on the total weight of component (K2).

In addition, component (K2) may in principle also comprise condensation catalysts (KK), water scavengers and silane crosslinkers (S), adhesion promoters (H), stabilizers (St), pigments and further additives. These are preferably the same materials which have already been described above as additives to component (K1).

In a preferred embodiment of the invention, components (K1) and (K2) are mixed in a weight ratio of preferably 1:30 to 30:1, preferably of 1:2 to 20:1, and more preferably in a ratio of 1:1.1 to 11:1.

The inventive adhesive and sealant components are suitable for numerous different substrates, for example mineral substrates, metals, plastics, glass, ceramic, painted surfaces, etc.

The inventive compounds are preferably used for production of seals or for bonding of different substrates.

The invention therefore provides moldings producible by mixing components (K1) and (K2) as claimed in any of claims 1 to 8, applying the mixture to a substrate or between two or more substrates and allowing the mixture to cure.

The moldings are a seal or a bond between different substrates.

All above symbols in the above formulae are each defined independently of one another. In all formulae, the silicon atom is tetravalent.

In the examples which follow, unless stated otherwise, all amounts and percentages are based on weight.

### EXAMPLES

Comparative Experiment 1:

One-Component Formulations Comprising a Silane-Terminated Polyether with Dimethoxymethylsilylmethyl Carbamate End Groups (GENIOSIL® STP-E10):

202.5 g of the silane-terminated polyether available under the GENIOSIL® STP-E10 name from Wacker Chemie AG are mixed in a laboratory planetary mixer from PC-Laborsystem, equipped with two crossarm mixers, at approx. 25° C. with 200 g of polypropylene glycol 2000 (from Dow Chemical) and 20 g of vinyltrimethoxysilane, obtainable under the GENIOSIL® XL10 (Wacker Chemie AG) name, at 200 rpm for 2 minutes. Thereafter, 30 g of a hydrophobic silica HDK® H18 (Wacker Chemie AG) are stirred in until it is distributed homogeneously. Subsequently, 540 g of Carbital C110 ground chalk (from Imerys) are introduced and the filler is digested while stirring at 600 rpm for 1 minute. After the incorporation of the chalk, 7.5 g of aminopropyltrimethoxysilane (GENIOSIL® GF96—Wacker Chemie AG) are distributed at 200 rpm over the course of 1 minute, and the mixture is homogenized under partial vacuum (approx. 100 mbar) at 600 rpm for 2 minutes and at 200 rpm for 1 minute and stirred to free it of bubbles.

The formulation is dispensed into 310 ml PE cartridges and stored at 25° C. for one day. The skin formation time (pot life) is determined as described in example 1. The mechanical properties are determined to DIN 53504 (tensile test) and DIN 53505 (Shore A hardness), as also described in example 1.

The results are compiled in table 1.

TABLE 1

| | Comparative experiment 1 |
|---|---|
| | 1K reference |
| GENIOSIL STP-E10 | 20.25% |
| PPG 2000 - Dow Chemical | 20.0% |
| GENIOSIL XL 10 | 2.0% |
| HDK H18 | 3.0% |
| Carbital 110 - Imerys | 54.0% |
| GENIOSIL GF 96 | 0.75% |
| | 100.00% |
| Skin formation time | 59 min |
| Mechanical properties after | |
| curing at 23° C., 50% r.h. for 14 days: | |
| 100% modulus | 1.76 |
| Shore A | 52 |
| Ultimate tensile strength | 144 |
| Breaking strength | 2.1 |

### Example 1

Two-Component Formulations Comprising a Silane-Terminated Polyether with Dimethoxymethylsilylmethyl Carbamate End Groups (GENIOSIL® STP-E10)

Base Component:

202.5 g of the silane-terminated polyether (with end groups of the formula (II) where R¹=methyl radical, R²=methyl radical, x=2 and y=1) available under the GENIOSIL® STP-E10 name from Wacker Chemie AG are mixed in a laboratory planetary mixer from PC-Laborsystem, equipped with two crossarm mixers, at approx. 25° C. with 20 g of vinyltrimethoxysilane, obtainable under the GENIOSIL® XL10 (Wacker Chemie AG) name, at 200 rpm for 1 minute. Thereafter, 30 g of a hydrophobic silica HDK® H18 (Wacker Chemie AG) are stirred in until it is distributed homogeneously. Subsequently, 250 g of Carbital C110 ground chalk (from Imerys) are introduced and the filler is digested while stirring at 600 rpm for 1 minute. After the incorporation of the chalk, 7.5 g of aminopropyltrimethoxysilane (GENIOSIL® GF96—Wacker Chemie AG) are distributed at 200 rpm over the course of 1 minute, and the mixture is homogenized under partial vacuum (approx. 100 mbar) at 600 rpm for 2 minutes and at 200 rpm for 1 minute and stirred to free it of bubbles. The formulation is dispensed into PE cartridges and stored at 25° C. for one day.

Hardener Component:

200 g of polypropylene glycol 2000 (from Dow Chemical) are introduced into the planetary mixer together with 290 g of Carbital C110 ground chalk (from Imerys) which are digested while stirring at 600 rpm for one minute. Subsequently, 10 g of distilled water are stirred in at 200 rpm for 1 minute, and the mixture is homogenized under partial vacuum (approx. 100 mbar) at 600 rpm for 2 minutes and at 200 rpm for 1 minute, and stirred to free it of bubbles. The formulation is dispensed into PE cartridges and stored at 25° C. for one day.

Mixing and Vulcanization:

The two components are weighed into the mixing cup in a ratio of 1:1 and homogenized in a Speedmixer from Hauschild at 2000 rpm for 1 min. The pot life of this mixture is determined in the mixing cup with the aid of a metal spatula. The time until the compound breaks off from the spatula is determined.

Determination of Mechanical Properties:

The samples are painted onto cut-out Teflon plaques of depth 2 mm and stored at 23° C., 50% relative air humidity (r.h.) for 14 days. The mechanical properties are determined to DIN 53504 (tensile test) and DIN 53505 (Shore A hardness). The results are compiled in table 2.

TABLE 2

| | Example 1 | |
|---|---|---|
| | 2K formulation (1:1) | |
| | Base | Hardener |
| GENIOSIL STP-E10 | 20.25% | — |
| PPG 2000 - Dow Chemical | — | 20.0% |
| GENIOSIL XL 10 | 2.0% | — |
| HDK H18 | 2.0% | — |
| Carbital 110 - Imerys | 25.0% | 29.0% |
| Dist. water | — | 1% |
| GENIOSIL ® GF 96 | 0.75% | — |
| | 50.0% | 50.0% |

| Pot life | 23 min |
|---|---|
| Mechanical properties after | |
| curing at 23° C., 50% r.h. for 14 days: | |
| 100% modulus | 1.69 |
| Shore A | 46 |
| Ultimate tensile strength | 135 |
| Breaking strength | 2.0 |

### Example 2

Two-Component Formulations Comprising a Silane-Terminated Polyether with Dimethoxymethylsilylmethyl Carbamate End Groups (GENIOSIL® STP-E10)

Analogous to example 1 with altered hardener component and mixing ratio. The hardener component is obtained by stirring 20 g of distilled water into 100 g of polypropylene glycol 2000. In the base component, HDK® V15 hydrophilic silica is used instead of the HDK® H18, and a slightly different mixing ratio.

The base and hardener components are each dispensed into PE cartridges and stored at 25° C. for one day.

The pot life and the mechanical properties are determined as described in example 1.

The results are compiled in table 3.

TABLE 3

| | Example 2 | |
|---|---|---|
| | 2K formulation | |
| | (approx. 7:1) | |
| | Base | Hardener |
| GENIOSIL STP-E10 | 25% | — |
| PPG 2000 - Dow Chemical | — | 10% |
| GENIOSIL XL 10 | 2% | |
| HDK V 15 | 2% | |
| Carbital 110 - Imerys | 57% | |
| Dist. water | — | 2% |
| GENIOSIL GF 96 | 2% | |
| | 88% | 12% |

| Pot life | 4 min |
|---|---|
| Mechanical properties after | |
| curing at 23° C., 50% r.h. for 14 days: | |
| 100% modulus | 2.3 |
| Shore A | 57 |
| Ultimate tensile strength | 110 |
| Breaking strength | 2.5 |

### Example 3

Two-Component Formulations Comprising a Silane-Terminated Polyether with Trimethoxysilylpropyl Carbamate End Groups (GENIOSIL® STP-E15)

A mixture is prepared analogously to example 1, except that the silane-terminated polyether GENIOSIL® STP-E10 is replaced by the silane-terminated polyether GENIOSIL® STP-E15 (with end groups of the formula (II) where R¹=methyl radical, x=3 and y=3), obtainable from Wacker Chemie AG.

The base and hardener components are each dispensed into PE cartridges and stored at 25° C. for one day.

The pot life and the mechanical properties are determined as described in example 1.

The results are compiled in table 4.

TABLE 4

| | Example 3 | |
|---|---|---|
| | 2K formulation | |
| | (1:1) | |
| | Base | Hardener |
| GENIOSIL STP-E15 | 20.25% | — |
| PPG 2000 - Dow Chemical | — | 20.0% |
| GENIOSIL XL 10 | 2.0% | |
| HDK H18 | 2.0% | |
| Carbital 110 - Imerys | 25.0% | 29.0% |
| Dist. water | — | 1% |
| GENIOSIL GF 96 | 0.75% | — |
| | 50.0% | 50.0% |

| Pot life | >4 h |
|---|---|
| Mechanical properties after | |
| curing at 23° C., 50% r.h. for 14 days: | |
| 100% modulus | — |
| Shore A | 50 |
| Ultimate tensile strength | 95 |
| Breaking strength | 1.5 |

Comparative Experiment 2:

Two-Component Formulations Comprising a Silane-Terminated Polyether with Dimethoxymethylsilylpropyl End Groups (MS Polymer S303H)

A mixture was prepared analogously to example 1, except that an “MS Polymer”, a silane-terminated polyether with dimethoxymethylsilylpropyl end groups (MS Polymer S303H, obtainable from Kaneka) is used instead of the silane-terminated polyether with dimethoxymethylsilylpropyl carbamate end groups (GENIOSIL® STP-E10).

The base and hardener components are each dispensed into PE cartridges and stored at 25° C. for one day. The pot life is determined as described in example 1.

The results are compiled in table 5.

The pot life is very long and the compound had not cured even after 7 days, and so it was not possible to determine the mechanical properties.

TABLE 5

| | Comparative experiment 2 | |
|---|---|---|
| | 2K formulation (1:1) | |
| | Base | Hardener |
| MS Polymer S303H | 20.25% | — |
| PPG 2000 - Dow Chemical | — | 20.0% |
| GENIOSIL XL 10 | 2.0% | — |
| HDK H18 | 2.0% | — |
| Carbital 110 - Imerys | 25.0% | 29.0% |
| Dist. water | — | 1% |
| GENIOSIL GF 96 | 0.75% | — |
| | 50.0% | 50.0% |

| Pot life | >24 h |
|---|---|
| Mechanical properties after | |
| curing at 23° C., 50% r.h. for 14 days: | |
| 100% modulus | Mechanical properties not |
| Shore A | determinable; product has |
| Ultimate tensile strength | not cured even after |
| Breaking strength | 7 days. |

### Example 4

Two-Component Formulations Comprising a Silane-Terminated Polyether with Dimethoxymethylsilylmethyl Carbamate End Groups (GENIOSIL® STP-E10)

Study of the Storage Stability of the Components:

Analogously to example 1, further mixtures were prepared using further components and examined:

GENIOSIL® GF80—glycidoxypropyltrimethoxysilane (from Wacker Chemie AG)

TINUVIN B75—stabilizer mixture from Ciba

The mixing, processing and determination of the pot life and the mechanical properties were as described above in example 1.

The base components A1 and A2 and the hardener component B were additionally previously stored closed at 70° C. for 4 weeks.

The results are compiled in table 6.

The hardening of the compounds did not give rise to any significant changes in the mechanical properties and in the pot lives after preceding storage of the base components and of the hardener component at 70° C. for 4 weeks.

TABLE 6
a:

| Base component | A1 | | A2 | |
|---|---|---|---|---|
| GENIOSIL STP-E10 | 175.00 | g | 172.50 | g |
| PPG 2000 - Dow Chemical | 10.00 | g | 10.00 | g |
| GENIOSIL XL 10 | 11.50 | g | 11.50 | g |
| GENIOSIL GF 80 | — | | 5.00 | g |
| Carbital 110 - Imerys | 280.00 | g | 277.50 | g |
| HDK H18 | 15.00 | g | 15.00 | g |
| TINUVIN B75 - Ciba | 1.00 | g | 1.00 | g |
| GENIOSIL GF 96 | 7.50 | g | 7.50 | g |

| Hardener component | B | |
|---|---|---|
| PPG 2000 - Dow Chemical | 485.00 | g |
| Dist. water | 15.00 | g |

b:

| Mixture | M1: 5:1 | M2: 2:1 | M3: 5:1 | M4: 2:1 |
|---|---|---|---|---|
| A1 | 83.33 g | 66.67 g | — | — |
| A2 | — | — | 83.33 g | 66.67 g |
| B | 16.67 g | 33.33 g | 16.67 g | 33.33 g |

c:

| Pot life | M1: | M2: | M3: | M4: |
|---|---|---|---|---|
| Pot life at 25° C. | 29 min. | 25 min. | 28 min. | 26 min. |
| Pot life at 25° C.- | — | 26 min. | — | 57 min. |
| stored at 70° C. | | | | |
| for 4 weeks | | | | |

Mechan. properties after curing at 23° C. for 7 days:

| Shore A | 49 | | 25 | | 51 | | 29 | |
|---|---|---|---|---|---|---|---|---|
| 100% modulus | 1.94 | N/mm² | 0.51 | N/mm² | — | | 0.71 | N/mm² |
| Ultimate tensile | 3.1 | N/mm² | 1.7 | N/mm² | 1.9 | N/mm² | 1.5 | N/mm² |
| strength | | | | | | | | |

| | | | | |
|---|---|---|---|---|
| Breaking | 175% | 277% | 91% | 168% |
| strength | | | | |

Mechan. properties after curing at 23° C. for 2 weeks + preceding storage at
70° C. for 4 weeks:

| Shore A | — | 24 | | — | 27 | |
|---|---|---|---|---|---|---|
| 100% modulus | — | 0.54 | N/mm² | — | 0.93 | N/mm² |
| Ultimate tensile | — | 1.6 | N/mm² | — | 1.2 | N/mm² |
| strength | | | | | | |

| | | | | |
|---|---|---|---|---|
| Breaking | — | 276% | — | 116% |
| strength | | | | |

1. A two-component adhesive or sealing compound (K) comprising a first component (K1) comprising
a silane-terminated prepolymer (A) having end groups of the general formula (II)
—O—CO—NH—(CH₂)_{y}—SiR²₃₋ₓ(OR¹)ₓ (II)
where
R¹ and R² are each independently hydrocarbyl radicals having 1-18 carbon atoms or ω-oxaalkylalkyl radicals having a total of 2-20 carbon atoms,
x is 2 or 3 and
y is a number from 1 to 10,
and a second component (K2) comprising water,
with the proviso that at least 50% of all molecules of prepolymer (A) do not have any additional urethane or urea units in the backbone of the prepolymer chain, and that more than 85% of all chain ends are terminated by silane functions.

2. The two-component adhesive or sealing compound (K) as claimed in claim 1, wherein the prepolymer (A) is an unbranched polyether having said end groups.

3. The two-component adhesive or sealing compound (K) as claimed in claim 1, wherein y in formula (II) has the value of 1.

4. The two-component adhesive or sealing compound (K) as claimed in claim 1, wherein the first component (K1) comprises further constituents selected from the group consisting of condensation catalysts (KK), water scavengers and silane crosslinkers (S), fillers (F), plasticizers (W), adhesion promoters (H), rheology aids (R) and stabilizers (St), color pigments, further customary assistants and additives, and mixtures thereof.

5. The two-component adhesive or sealing compound (K) as claimed in claim 1, wherein the compound is free of heavy metal-containing catalysts (KK).

6. The two-component adhesive or sealing compound (K) as claimed in claim 1, wherein the compound is free of tin catalysts (KK).

7. The two-component adhesive or sealing compound (K) as claimed in claim 1, wherein the second component (K2) comprises plasticizer (W).

8. The two-component adhesive or sealing compound (K) as claimed in claim 1, wherein the second component (K2) comprises a filler (F).

9. A molding producible by mixing components (K1) and (K2) as claimed in claim 1,
applying the mixture to a substrate or between two or more substrates, and
allowing the mixture to cure.
